(19) United States
(12) Patent Application Publication
(10) Pub. No.: US 2012/0054052 A1
(43) Pub. Date: Mar. 1, 2012

(54) STORE SYSTEM, SALES REGISTRATION APPARATUS, AND CONTROL METHOD

(75) Inventor: Satoshi Wakebe, Tokyo (JP)

(73) Assignee: TOSHIBA TEC KABUSHIKI KAISHA, Tokyo (JP)

(21) Appl. No.: 13/220,920

(22) Filed: Aug. 30, 2011

(30) Foreign Application Priority Data
Sep. 1, 2010 (JP) 2010-196206

(51) Int. Cl. G06Q 30/00

(52) U.S. Cl. 705/23

(57) ABSTRACT

According to one embodiment, a store system includes: a reading apparatus including: an image capturing section configured to capture a picked-up image; a code reading section configured to detect a code symbol represented on a commodity included in the captured image and read code information corresponding to the code symbol; and an output section configured to output the read code information; and a sales registration apparatus including: a sales registering section configured to register, referring to commodity registration information, sales of the commodity specified by the output code information; an acquiring section configured to acquire, if information related to the output code information is unregistered in the commodity registration information, an image of the commodity from which the unregistered code information is read; and a provisional registration section configured to provisionally register the image of the commodity in the commodity registration information in association with the unregistered code information.

### CROSS-REFERENCE TO RELATED APPLICATIONS

This application is based upon and claims the benefit of priority from the prior Japanese Patent Application No. 2010-196206, filed on Sep. 1, 2010; the entire contents of which are incorporated herein by reference.

### FILED

Embodiments described herein relate generally to a store system, a sales registration apparatus, and a control method.

### BACKGROUND

In stores such as a supermarket, commodities affixed with code symbols such as barcodes and two-dimensional codes (e.g., QR codes (registered trademark)) are sold. The code symbols of the commodities are obtained by non-intrinsically and latently symbolizing, on the basis of a fixed rule, codes for specifying the commodities. The code symbols are optically read and decoded by a code reading apparatus such as a barcode scanner.

Some code reading apparatus picks up an image of a commodity or the like with a digital camera such as a CCD (Charge Coupled Device) image sensor, detects a code symbol from the picked-up image, and decodes the code symbol. A store clerk takes out a commodity stored in a shopping basket carried onto a counter table by a customer, holds the commodity over the digital camera of the code reading apparatus to cause the digital camera to optically read a code of the commodity to be purchased by the customer, and registers sales of the commodity.

If a commodity code read by the code reading apparatus or a unit price or the like of a commodity specified by the commodity code is unregistered in a database, a commodity to be purchased by a customer cannot be specified from the commodity code or sales of the commodity cannot be registered. In such a case, the store clerk performs key operation and inputs information, which the store clerk can input through the key operation on the spot, such as a department code indicating a department to which the unregistered commodity belongs, the unit price of the commodity, and the like and registers sales of the commodity. The information input by the store clerk through the key operation is provisionally registered in a database in association with the commodity code read by the code reading apparatus.

In the information concerning the commodity provisionally registered in this way, necessary information (e.g., a commodity name) needs to be regularly registered as soon as possible. However, since only the department code, the unit price, and the like of the commodity are registered during the provisional registration, in some case, it is difficult to specify the provisionally-registered commodity.

### DESCRIPTION OF THE DRAWINGS

FIG. 1 is a perspective view of a checkout system;

FIG. 2 is a block diagram of hardware configurations of a POS terminal and a reading apparatus;

FIG. 3 is a conceptual diagram of an example of a data structure of a PLU file;

FIG. 4 is a block diagram of functional configurations of CPUs;

FIG. 5 is a flowchart for explaining an example of the operation of the checkout system; and

FIG. 6 is a conceptual diagram of an example of a reading area in a reading window.

### DETAILED DESCRIPTION

In general, according to one embodiment, a store system includes: a reading apparatus including: an image capturing section configured to capture an image picked up by an image pickup section; a code reading section configured to detect a code symbol represented on a commodity included in the captured image and read code information corresponding to the code symbol; and an output section configured to output the read code information; and a sales registration apparatus including: a sales registering section configured to register, referring to commodity registration information in which information related to a commodity is registered in advance for each kind of code information, sales of the commodity specified by the output code information; an acquiring section configured to acquire, if information related to the output code information is unregistered in the commodity registration information, an image of the commodity from which the unregistered code information is read; and a provisional registration section configured to provisionally register the image of the commodity from which the unregistered code information is read in the commodity registration information in association with the unregistered code information.

In general, according to another embodiment, a sales registration apparatus includes: a code reading section configured to detect a code symbol represented on a commodity included in an image picked up by an image pickup section and read code information corresponding to the code symbol; a sales registering section configured to register, referring to commodity registration information in which information related to a commodity is registered in advance for each kind of code information, sales of the commodity specified by the read code information; an acquiring section configured to acquire, if information related to the read code information is unregistered in the commodity registration information, an image of the commodity from which the unregistered code information is read; and a provisional registration section configured to provisionally register the image of the commodity from which the unregistered code information is read in the commodity registration information in association with the unregistered code information.

In general, according to still another embodiment, a control method is a control method for a sales registration apparatus including a code reading section configured to detect a code symbol represented on a commodity included in an image picked up by an image pickup section and read code information corresponding to the code symbol, the method including: registering, referring to commodity registration information in which information related to a commodity is registered in advance for each kind of code information, sales of the commodity specified by the read code information; acquiring, if information related to the read code information is unregistered in the commodity registration information, an image of the commodity from which the unregistered code information is read; and provisionally registering the image of the commodity from which the unregistered code information is read in the commodity registration information in association with the unregistered code information.

A store system, a sales registration apparatus, and a control method according to an embodiment are explained below with reference to the accompanying drawings using a checkout system as an example. The checkout system includes a POS (Point Of Sale) terminal functioning as the sales registration apparatus that performs registration and settlement of commodities purchased in one transaction and a code reading apparatus that reads commodity codes and the like affixed to the commodities. The checkout system is an example of the store system. This embodiment is an application example to a checkout system installed in a store such as a supermarket.

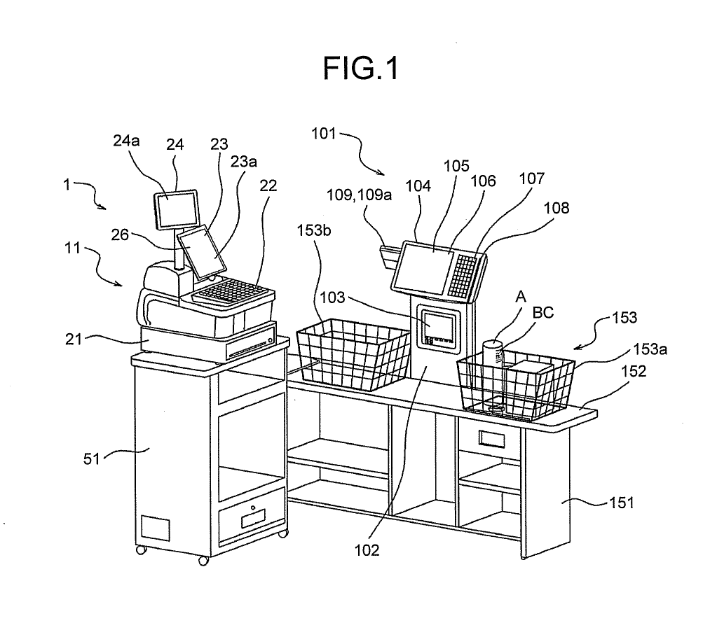

FIG. 1 is a perspective view of a checkout system 1. As shown in FIG. 1, the checkout system 1 includes a POS terminal 11 that performs registration and settlement of commodities purchased on one transaction. The POS terminal 11 is placed on the upper surface of a drawer 21 on a checkout table 51. The drawer 21 is controlled to be opened by the POS terminal 11. A keyboard 22 operated to be pressed by an operator (a store clerk) is arranged on the upper surface of the POS terminal 11. A display device 23 configured to display information to the store clerk who operates the keyboard 22 is provided further on the depth side than the keyboard 22 viewed from the store clerk. The display device 23 displays information on a display surface 23a thereof. A touch panel 26 is laminated on the display surface 23a. A customer display device 24 is vertically provided to freely rotate further on the depth side than the display device 23. The customer display device 24 displays information on a display surface 24a thereof. In the customer display device 24 shown in FIG. 1, the display surface 24a is faced to the front side in FIG. 1. However, the customer display device 24 is rotated such that the display surface 24a faces the depth side in FIG. 1, whereby the customer display device 24 displays information to a customer.

A counter table 151 having a laterally long table shape is arranged to form an L shape with the checkout table 51 on which the POS terminal 11 is placed. A loading surface 152 is formed on the upper surface of the counter table 151. A shopping basket 153 that stores a commodity A affixed with a barcode BC is placed on the loading surface 152. The shopping basket 153 can be considered separately as a first shopping basket 153a carried in by the customer and a second shopping basket 153b located in a position across a reading apparatus 101 from the first shopping basket 153a.

The reading apparatus 101 connected to the POS terminal 11 to freely transmit and receive data to and from the POS terminal 11 is set on the loading surface 152 of the counter table 151. The reading apparatus 101 includes a housing 102 having a thin rectangular shape. A reading window 103 is arranged in the front of the housing 102. A display and operation section 104 is attached to an upper part of the housing 102. A display device 106, on the surface of which a touch panel 105 is laminated, is provided in the display and operation section 104 A keyboard 107 is disposed on the right of the display device 106. A card reading groove 108 of a not-shown card reader is provided on the right of the keyboard 107. A customer display device 109 provided to be faced to the customer and used for displaying information to the customer is set on the left depth side on the rear surface of the display and operation section 104 viewed from the store clerk. A customer touch panel 109a is laminated on a display surface of the customer display device 109.

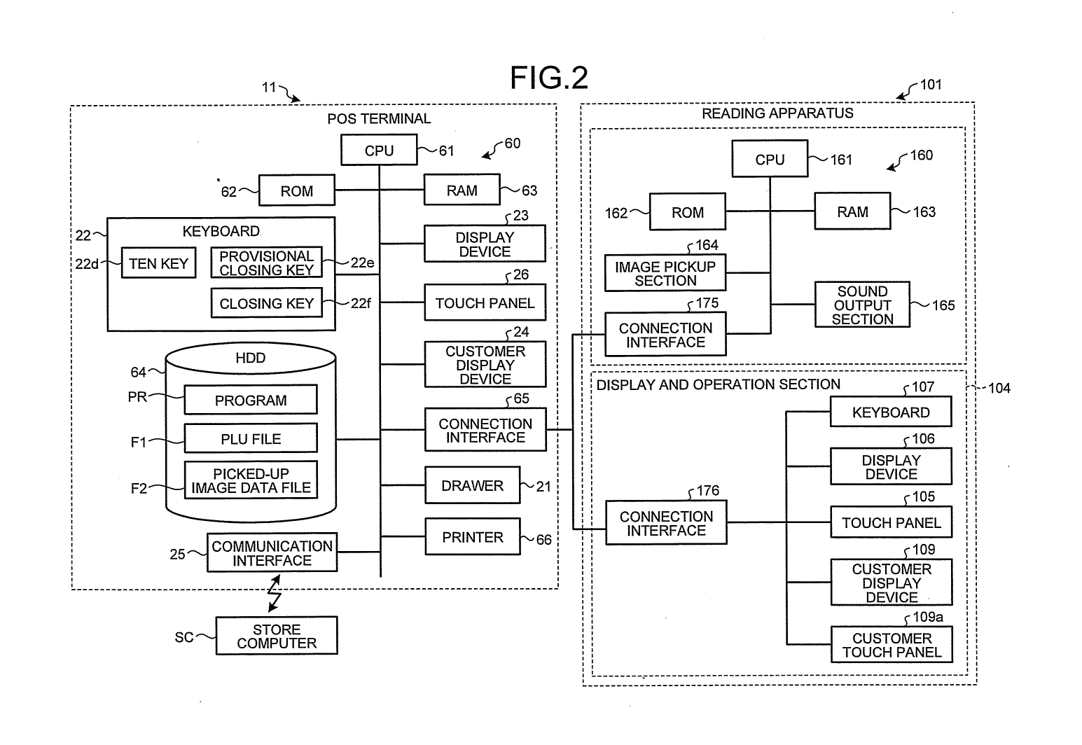

The commodity A purchased in one transaction is stored in the first shopping basket 153a carried in by the customer. The barcode BC obtained by symbolizing a commodity code (code information) concerning the commodity A is represented on the commodity A. The commodity A is moved to the second shopping basket 153b by a hand of the operator. In this moving process, the barcode BC is faced to the reading window 103 of the reading apparatus 101. When the barcode BC is faced to the reading window 103, an image pickup section 164 (see FIG. 2) arranged on the depth side of the reading window 103 picks up an image of the barcode BC. The reading apparatus 101 detects and decodes the barcode BC represented on the commodity A included in the image picked up by the image pickup section 164 to read a commodity code corresponding to the commodity A. Subsequently, the reading apparatus 101 outputs the read commodity code to the POS terminal 11.

The commodity code represented as the barcode BC is a code allocated to each commodity to specify the commodity A. As an example, the commodity code is a JAN (Japanese Article Number) code, which is a thirteen-digit number. In this embodiment, the barcode BC is explained as an example of a code symbol. However, it goes without saying that the code symbol may be a two-dimensional code such as a QR code (registered trademark)

FIG. 2 is a block diagram of hardware configurations of the POS terminal 11 and the reading apparatus 101. The POS terminal 11 includes a microcomputer 60 functioning as an information processing section configured to execute information processing. The microcomputer 60 is configured by connecting, via a bus, a ROM (Read Only Memory) 62 and a RAM (Random Access Memory) 63 to a CPU (Central Processing Unit) 61 configured to execute various kinds of arithmetic processing and control sections.

All of the drawer 21, the keyboard 22, the display device 23, the touch panel 26, and the customer display device 24 are connected to the CPU 61 of the POS terminal 11 via various input output circuits (all of which are not shown in the figure) These devices are controlled by the CPU 61.

The keyboard 22 includes a ten key 22d, on the upper surface of which numbers “1”, “2”, “3”, and the like and a multiplication operator “x” are displayed, a provisional closing key 22e, and a closing key 22f. The keyboard 22 outputs an operation input of the store clerk by the ten key 22d, the provisional closing key 22e, and the closing key 22f to the CPU 61. The keyboard 22 is operating means configured to receive operation from the store clerk. The POS terminal 11 receives an operation input of the store clerk from the keyboard 22 to acquire information related to provisional registration of a commodity under the control by the CPU 61. Specifically, the POS terminal 11 acquires a link code indicating a link destination such as a department of a commodity to be provisionally registered, a unit price of the commodity, and the like.

A HDD (Hard Disk Drive) 64 is connected to the CPU 61 of the POS terminal 11. A computer program and various files are stored in the HDD 64. When the POS terminal 11 is started, all or a part of the computer program and the files stored in the HDD 64 are copied to the RAM 63 and sequentially executed by the CPU 61. An example of the computer program stored in the HDD 64 is a computer program PR for commodity sales data processing. Examples of the files stored in the HDD 64 are a PLU file F1 distributed from a store computer SC and stored in the HDD 64 and a picked-up image data file F2 in which a picked-up image of a commodity to be provisionally registered is stored.

The PLU file F1 is a file in which, for each commodity code uniquely allocated to each commodity, information related to the commodity such as a name and a unit price of the commodity is stored. In other words, the PLU file F1 is commodity registration information in which information related to a commodity is registered in advance for each kind of code information (commodity code).

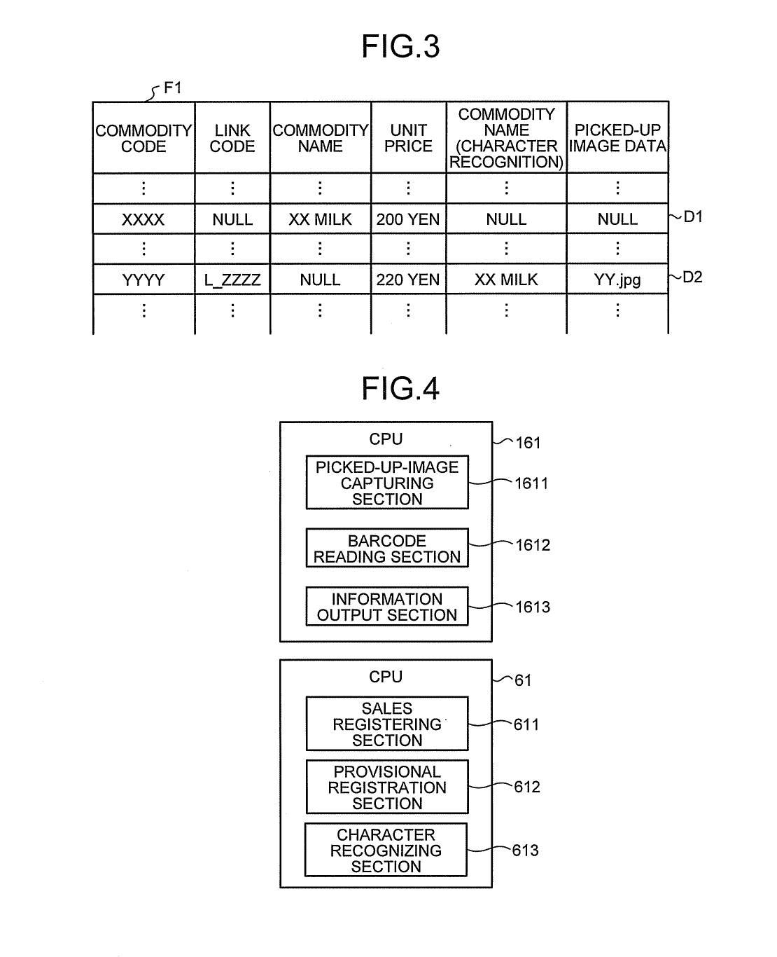

FIG. 3 is a conceptual diagram of an example of a data structure of the PLU file F1. Data D1 shown in FIG. 3 as an example is regularly-registered registration data registered in advance by the store computer SC or the like rather than being provisionally registered. Data D2 is provisionally-registered registration data provisionally registered. In the regularly-registered data D1, “XXXX” as “commodity code”, “XX milk” as “commodity name”, and “200 yen” as “unit price” are registered. In the provisionally-registered data D2, “L_ZZZ” and “220 yen” as “link code” and “unit price” acquired as information related to provisional registration, “YY milk” as “commodity name” recognized as characters from a picked-up image of a commodity to be provisionally registered, and “YY.jpg” as a file name or the like of the picked-up image data file F2 in which the picked-up image is stored are registered. The POS terminal 11 can register, referring to the data D1 and the data D2 registered in the PLU file F1 with a commodity code read by the reading apparatus 101, sales of a commodity corresponding to the read commodity code.

A communication interface 25 for executing data communication with the store computer SC is connected to the CPU 61 of the POS terminal 11 via an input and output circuit (not shown). The store computer SC is set in a backyard or the like of the store. The PLU (Price Look Up) file F1 to be distributed to the POS terminal 11 is stored in a HDD (not shown) of the store computer SC. The store computer SC can totalize the data D2 (see FIG. 3) provisionally registered in the POS terminal 11 by acquiring the PLU file F1 and the picked-up image data file F2 stored by the HDD 64 of the POS terminal 11 via the communication interface 25 and comparing the PLU file F1 and the picked-up image data file F2 with the PLU file F1 stored by the HDD of the store computer SC. The store computer SC can totalize data provisionally registered by POS terminals 11 in the entire store by performing this totalization for all the POS terminals 11 set in the store.

A connection interface 65 enabling data transmission and reception between the POS terminal 11 and the reading apparatus 101 is connected to the CPU 61 of the POS terminal 11. Therefore, the connection interface 65 is connected to the reading apparatus 101. A printer 66 configured to perform printing on a receipt or the like is connected to the CPU 61 of the POS terminal 11. The POS terminal 11 prints, for example, transaction contents (a settlement amount and granted points) of one transaction on the receipt under the control by the CPU 61.

The reading apparatus 101 includes a microcomputer 160. The microcomputer 160 is configured by connecting a ROM 162 and a RAM 163 to a CPU 161 via a bus. A computer program to be executed by the CPU 161 is stored in the ROM 162. The image pickup section 164 and a sound output section 165 are connected to the CPU 161 via various input and output circuits (all of which are not shown). The operation of the image pickup section 164 and the sound output section 165 is controlled by the CPU 161. The display and operation section 104 is connected to the POS terminal 11 via a connection interface 176. The operation of the display and operation section 104 is controlled by the CPU 61 of the POS terminal 11.

The image pickup section 164 is a CCD image sensor, a CMOS (Complementary Metal Oxide Semiconductor) image sensor, or the like and performs image pickup from the reading window 103 under the control by the CPU 161. For example, the image pickup section 164 performs image pickup of a 30 fps moving image. Frame images sequentially picked up by the image pickup section 164 at a predetermined frame rate are stored in the RAM 163. The sound output section 165 is a sound circuit, a speaker, and the like for generating warning sound or the like set in advance. The sound output section 165 performs alerting by sound such as the warning sound under the control by the CPU 161.

Further, a connection interface 175 connected to the connection interface 65 of the POS terminal 11 and enabling data transmission and reception between the reading apparatus 101 and the POS terminal 11 is connected to the CPU 161. A commodity code read from an image picked up by the image pickup section 164 of the reading apparatus 101, the picked-up image, and the like are output via the connection interface 175 and input to the POS terminal 11 via the connection interface 65 under the control by the CPU 161.

Functional sections of the CPU 161 and the CPU 61 realized by the CPU 161 and the CPU 61 sequentially executing computer programs are explained with reference to FIG. 4. FIG. 4 is a block diagram of functional configurations of the CPU 161 and the CPU 61. As shown in FIG. 4, the CPU 161 sequentially executes the computer program to thereby include functions of a picked-up-image capturing section 1611, a barcode reading section 1612, and an information output section 1613. Similarly, the CPU 61 includes functions of a sales registering section 611, a provisional registration section 612, and a character recognizing section 613.

The picked-up-image capturing section 1611 outputs an image pickup ON signal to the image pickup section 164 and causes the image pickup section 164 to start an image pickup operation. The picked-up-image capturing section 1611 sequentially captures frame images picked up by the image pickup section 164 and stored in the RAM 163 after the start of an image pickup operation. The capturing of the frame images by the picked-up-image capturing section 1611 is performed in the order of the storage in the RAM 163.

The barcode reading section 1612 detects a code symbol included in a frame image captured by the picked-up-image capturing section 1611 and reads code information such as a commodity code corresponding to the code symbol. Specifically, the barcode reading section 1612 performs detection of a barcode by a pattern matching technique, detection of a two-dimensional code from a predetermined finder pattern, or the like from an image obtained by binarizing the captured frame image.

Subsequently, the barcode reading section 1612 converts the detected barcode or two-dimensional code into code information (e.g., a JAN code) conforming to a predetermined rule to read code information corresponding to the detected barcode or two-dimensional code. The information output section 1613 outputs the code information read by the barcode reading section 1612 to the POS terminal 11 via the connection interface 175. The information output section 1613 outputs, according to a request from the POS terminal 11, an image of a commodity picked up by the image pickup section 164 to the POS terminal via the connection interface 175.

The sales registering section 611 specifies the commodity A read by the barcode reading section 1612 referring to the PLU file F1 on the basis of the code information (a commodity code) output from the reading apparatus 101. Subsequently, the sales registering section 611 registers sales of the specified commodity A. The sales registering section 611 allocates a unique transaction number to each transaction and gives this transaction number to the commodity A in registering the sales of the commodity A. The registration of the sales by the sales registering section 611 is performed by recording information such as a commodity code, a commodity name, a unit price, a quantity, date and time, and a transaction number in a sales master file (not shown) or the like.

If the sales registering section 611 cannot specify the commodity A, i.e., if the commodity code output from the reading apparatus 101 is unregistered in the PLU file F1, the provisional registration section 612 provisionally registers information related to the commodity code in the PLU file F1. Specifically, the provisional registration section 612 receives an operation input of the store clerk from the keyboard 22 to acquire information related to the provisional registration such as a link code and a unit price. The provisional registration section 612 requests the reading apparatus 101 to transmit an image of the commodity A that cannot be specified and acquires an image of the commodity A picked up by the reading apparatus 101. The provisional registration section 612 acquires a character (a character string) included in the acquired image of the commodity A through character recognition processing (OCR) of the character recognizing section 613. The provisional registration section 612 registers the information related to the provisional registration, the character recognized by the character recognizing section 613, and the image of the commodity A in the PLU file F1 in association with the unregistered commodity code.

The character recognizing section 613 applies the character recognition processing (OCR) to the image of the commodity A picked up by the reading apparatus 101 to recognize the character included in the image. If the character recognizing section 613 recognizes plural characters (character strings) from the image of the commodity A, the character recognizing section 613 adopts a character (a character string) having a largest size as a recognition result. In the commodity A, a commodity name is often written with the character having the largest size. Therefore, it is possible to recognize the commodity name by adopting the character having the largest size as the recognition result.

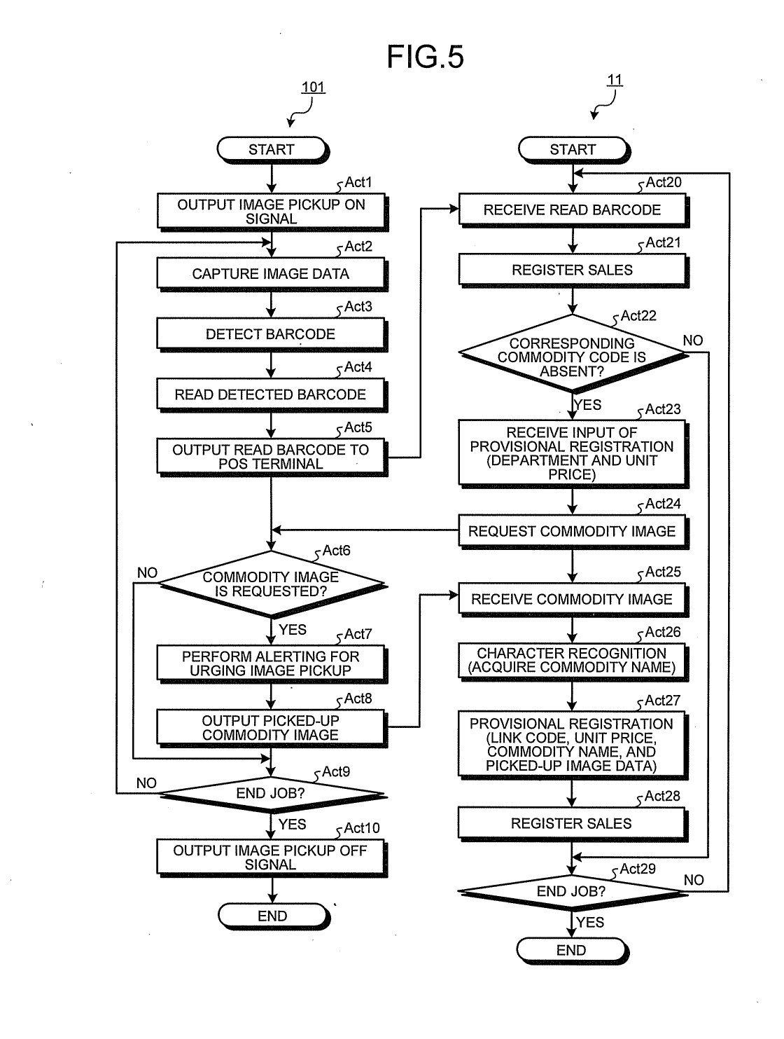

The operation of the checkout system 1 is explained in detail below. FIG. 5 is a flowchart for explaining an example of the operation of the checkout system 1.

First, the operation on the reading apparatus 101 side is explained. As shown in FIG. 5, if processing is started according to, for example, the start of commodity registration by the POS terminal 11, the picked-up-image capturing section 1611 outputs an image pickup ON signal to the image pickup section 164 and causes the image pickup section 164 to start image pickup (Act 1). Subsequently, the picked-up-image capturing section 1611 captures a frame image (a picked-up image) picked up by the image pickup section 164 and stored in the RAM 163 (Act 2).

Subsequently, the barcode reading section 1612 detects a barcode included in the frame image captured by the picked-up-image capturing section 1611 (Act 3) and reads a commodity code corresponding to the detected barcode (Act 4).

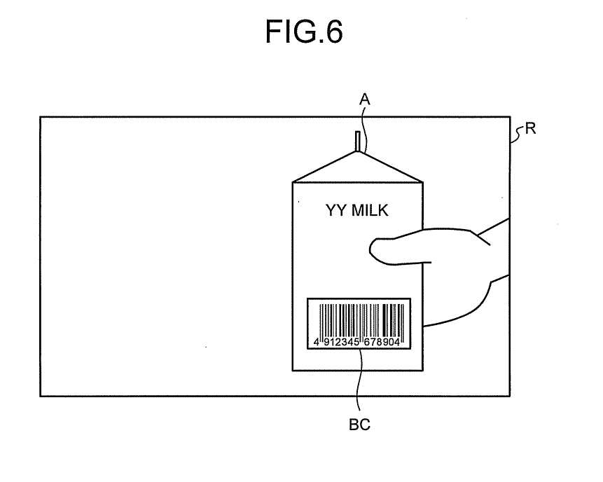

FIG. 6 is a conceptual diagram of an example of a reading area R in the reading window 103. Specifically, FIG. 6 is a conceptual diagram of an example of the reading area R in reading of the commodity A. As shown in FIG. 6, if the commodity A is reflected in the reading area R in the moving process of the commodity A, in Act 4, a commodity code corresponding to the barcode BC represented on the commodity A is read.

Subsequently, the information output section 1613 outputs the commodity code read by the barcode reading section 1612 to the POS terminal via the connection interface 175 (Act 5). The CPU 161 determines whether a request for a picked-up image of the commodity A is received from the POS terminal 11 (Act 6). If the request is not received (No in Act 6), the CPU 161 advances the processing to Act 9.

If the request is received (Yes in Act 6), the CPU 161 performs alerting for urging image pickup for the commodity A on a display screen of the display device 106 or the like (Act 7). For example, the CPU 161 outputs, to the CPU 61 via the connection interface 175, display data for displaying a message for urging the store clerk to hold the portion of the barcode BC or the commodity name of the commodity over the reading window 103 and performs display on the display device 106. Subsequently, the information output section 1613 outputs the image of the commodity A picked up by the image pickup section 164 to the POS terminal 11 via the connection interface 175 (Act 8) and advances the processing to Act 9.

In Act 9, the CPU 161 determines whether a job is ended according to, for example, notification of the end of commodity registration from the POS terminal 11. If the job is continued (No in Act 9), the CPU 161 returns the processing to Act 2 and continues the processing. If the job is ended (Yes in Act 9), the picked-up-image capturing section 1611 outputs an image pickup OFF signal to the image pickup section 164 and ends the image pickup by the image pickup section 164 (Act 10). The CPU 161 ends the processing.

The operation on the POS terminal 11 side is explained. As shown in FIG. 5, if processing is started according to, for example, the start of commodity registration by an operation instruction from the keyboard 22, the CPU 61 receives, via the connection interface 65, a commodity code obtained by reading the barcode BC and output by the reading apparatus 101 (Act 20). Subsequently, the sales registering section 611 registers sales of the specified commodity A referring to the PLU file F1 on the basis of the commodity code output from the reading apparatus 101 (Act 21).

Subsequently, the CPU 61 determines whether the commodity code output from the reading apparatus 101 is unregistered in the PLU file F1 and a commodity code corresponding to the commodity code is absent in the PLU file F1 (Act 22). If a commodity code corresponding to the commodity code is present (No in Act 22), since the sales of the commodity A are registered on the basis of the commodity code output from the reading apparatus 101, the CPU 61 advances the processing to Act 29 without performing the processing in Acts 23 to 28.

If a commodity code corresponding to the commodity code is absent (Yes in Act 22), the commodity A is not specified on the basis of the commodity code output from the reading apparatus 101 and the sales of the commodity A are not registered. Therefore, the CPU 61 performs processing in Acts 23 to 28 related to provisional registration of the commodity A and sales registration of the provisionally-registered commodity A.

In Act 23, the provisional registration section 612 receives an operation input of the store clerk from the keyboard 22 and receives the input of information related to the provisional registration such as a department (a link code) and a unit price. Subsequently, the provisional registration section 612 requests, via the connection interface 65, the reading apparatus 101 to transmit an image of the commodity A that cannot be specified (Act 24) and receives an image of the commodity A picked up by the reading apparatus 101 (Act 25).

Subsequently, the character recognizing section 613 applies character recognition (OCR) to the image of the commodity A picked up by the reading apparatus 101 (Act 26). As explained above, the character recognizing section 613 acquires a commodity name through the character recognition.

The provisional registration section 612 provisionally registers the information related to the provisional registration and a character recognized by the character recognizing section 613 in the PLU file F1 in association with the unregistered commodity code. The provisional registration section 612 stores the image of the commodity A in the picked-up image data file F2 in association with the unregistered commodity code (Act 27). Specifically, as indicated by the data D2 shown in FIG. 3, “link code”, “unit price”, “commodity name (character recognition)”, and “picked-up image data” are provisionally registered. The sales registering section 611 registers sales of the commodity A according to the provisionally-registered data (e.g., the data D2 shown in FIG. 3) (Act 28).

For example, if the data D2 is unregistered in the PLU file F1 shown in FIG. 3, the commodity A shown in FIG. 6 cannot be specified if the commodity A is read and “YYYY” corresponding to the barcode BC is acquired. Therefore, the processing in Acts 23 to 28 is performed and information such as “L_ZZZZ” and “220 yen” is acquired from an operation input of the store clerk. A commodity name such as “YY milk” included in the picked-up image of the commodity A is acquired by character recognition. Provisional registration of the data D2 in the PLU file F1 and sales registration of the commodity A are performed.

In Act 29, the CPU 61 determines whether a job is ended according to the end of commodity registration by an operation instruction from the keyboard 22. If the job is continued (No in Act 29), the CPU 61 returns the processing to Act 20 and continues the processing. If the job is ended (Yes in Act 29), the CPU 61 ends the processing.

As explained above, in the checkout system 1, the reading apparatus 101 detects a code symbol included in an image picked up by the image pickup section 164 and reads code information corresponding to the code symbol (Act 4) and outputs the read code information to the POS terminal 11 (Act 5). The POS terminal 11 registers sales of a commodity specified by the output code information (Act 21). If the output code information is unregistered, the POS terminal 11 acquires information related to provisional registration and an image of the commodity from which the unregistered code information is read (Acts 23 and 25) and recognizes a character included in the acquired image of the commodity (Act 26). The POS terminal 11 provisionally registers the acquired information related to the provisional registration and the recognized character in association with the unregistered code information (Act 27). Therefore, in the checkout system 1, since the recognized character included in the image of the commodity is provisionally registered together with the acquired information related to the provisional registration in association with the unregistered code information, in finding out the provisionally-registered commodity later, it is possible to refer to the character included in the image of the commodity. Therefore, it is possible to reduce labor and time for finding out the commodity. Further, in the checkout system 1, since the image of the commodity is also provisionally registered in association with the unregistered code information, it is possible to refer to the image in finding out the provisionally-registered commodity later.

The computer programs executed in the POS terminal 11 and the reading apparatus 101 according to this embodiment are provided while being incorporated in ROMs or the like in advance. The computer programs executed in the POS terminal 11 and the reading apparatus 101 according to this embodiment may be provided while being recorded in a computer-readable recording medium such as a CD-ROM (Compact Disc Read Only Memory), a flexible disk (FD), a CD-R (Compact Disc Recordable), or a DVD (Digital Versatile Disk) as files of an installable format or an executable format.

The computer programs executed in the POS terminal 11 and the reading apparatus 101 according to this embodiment may be provided while being stored on a computer connected to a network such as the Internet and downloaded through the network. The computer programs executed in the POS terminal 11 and the reading apparatus 101 according to this embodiment may be provided or distributed through the network such as the Internet.

The computer programs executed in the POS terminal 11 and the reading apparatus 101 according to this embodiment have a module configuration including the sections explained above (the sales registering section 611, the provisional registration section 612, the character recognizing section 613, the picked-up-image capturing section 1611, the barcode reading section 1612, and the information output section 1613). As actual hardware, CPUs (processors) read out the computer programs from the ROMs and execute the computer programs, whereby the sections are loaded onto main storages and the sales registering section 611, the provisional registration section 612, the character recognizing section 613, the picked-up-image capturing section 1611, the barcode reading section 1612, and the information output section 1613 are generated on the main storages.

Further effects and modifications can be easily derived by those skilled in the art. Therefore, a wider form of the present invention is not limited to the specific details and the representative embodiment represented and described above. Therefore, various changes are possible without departing from the spirit and the scope of the general concept of the invention defined by the appended claims and equivalents of the claims.

What is claimed is:

1. A store system comprising:
a reading apparatus including:
an image capturing section configured to capture an image picked up by an image pickup section;
a code reading section configured to detect a code symbol represented on a commodity included in the captured image and read code information corresponding to the code symbol; and
an output section configured to output the read code information; and
a sales registration apparatus including:
a sales registering section configured to register, referring to commodity registration information in which information related to a commodity is registered in advance for each kind of code information, sales of the commodity specified by the output code information;
an acquiring section configured to acquire, if information related to the output code information is unregistered in the commodity registration information, an image of the commodity from which the unregistered code information is read; and
a provisional registration section configured to provisionally register the image of the commodity from which the unregistered code information is read in the commodity registration information in association with the unregistered code information.

2. The store system according to claim 1, wherein
the acquiring section acquires information related to the provisional registration if the information related to the output code information is unregistered in the commodity registration information, and
the provisional registration section provisionally registers the acquired information related to the provisional registration in the commodity registration information in association with the unregistered code information.

3. The store system according to claim 2, wherein the sales registering section registers sales of the commodity with the acquired information related to the provisional registration if the information related to the output code information is unregistered in the commodity registration information.

4. The store system according to claim 1, further comprising a character recognizing section configured to recognize a character included in the acquired image of the commodity, wherein
the provisional registration section provisionally registers a character recognized from the image of the commodity from which the unregistered commodity code is read in the commodity registration information in association with the unregistered code information.

5. The store system according to claim 4, wherein
the acquiring section acquires an image including a commodity name of the commodity from which the unregistered code information is read,
the character recognizing section recognizes the commodity name included in the acquired image of the commodity, and
the provisional registration section provisionally registers the recognized commodity name in the commodity registration information in association with the unregistered code information.

6. The store system according to claim 4, wherein the character recognizing section recognizes a character having a largest size among characters included in the acquired image of the commodity.

7. The store system according to claim 1, wherein the acquiring section causes the output section of the reading apparatus to output an image picked up by the image pickup section concerning the commodity from which the unregistered code information is read and acquires the image of the commodity.

8. A sales registration apparatus comprising:
a code reading section configured to detect a code symbol represented on a commodity included in an image picked up by an image pickup section and read code information corresponding to the code symbol;
a sales registering section configured to register, referring to commodity registration information in which information related to a commodity is registered in advance for each kind of code information, sales of the commodity specified by the read code information;
an acquiring section configured to acquire, if information related to the read code information is unregistered in the commodity registration information, an image of the commodity from which the unregistered code information is read; and
a provisional registration section configured to provisionally register the image of the commodity from which the unregistered code information is read in the commodity registration information in association with the unregistered code information.

9. The apparatus according to claim 8, further comprising a character recognizing section configured to recognize a character included in the acquired image of the commodity, wherein
the provisional registration section provisionally registers a character recognized from the image of the commodity from which the unregistered commodity code is read in the commodity registration information in association with the unregistered code information.

10. A control method for a sales registration apparatus including a code reading section configured to detect a code symbol represented on a commodity included in an image picked up by an image pickup section and read code information corresponding to the code symbol,
the method comprising:
registering, referring to commodity registration information in which information related to a commodity is registered in advance for each kind of code information, sales of the commodity specified by the read code information;
acquiring, if information related to the read code information is unregistered in the commodity registration information, an image of the commodity from which the unregistered code information is read; and
provisionally registering the image of the commodity from which the unregistered code information is read in the commodity registration information in association with the unregistered code information.
